(19) United States
(12) Patent Application Publication
(10) Pub. No.: US 2016/0366994 A1
(43) Pub. Date: Dec. 22, 2016

(54) FOLDING UMBRELLA HINGE AND METHOD OF USE

(71) Applicants: Edouard GOROUVEIN, Thornhill (CA); Maksim GOROUVEIN, Thornhill (CA)

(72) Inventors: Edouard GOROUVEIN, Thornhill (CA); Maksim GOROUVEIN, Thornhill (CA)

(21) Appl. No.: 15/095,573

(22) Filed: Apr. 11, 2016

Related U.S. Application Data
(63) Continuation-in-part of application No. 14/859,529, filed on Sep. 21, 2015, now abandoned.
(60) Provisional application No. 62/181,260, filed on Jun. 18, 2015.

(51) Int. Cl. A45B 19/08; A45B 25/00; F16C 11/04; A45B 9/02

(52) U.S. Cl. CPC A45B 19/08; A45B 9/02; A45B 25/00; F16C 11/04

(57) ABSTRACT

The objective of the invention is to improve properties of an umbrella taking into account convenience and comfort through ergonometric requirements, and to create a new fashion trend. The invention involves an umbrella with a hinged locking mechanism that can be in either an open position or closed position with a locking pin operated by a button to transition between closed and open positions.

### CROSS-REFERENCE TO RELATED APPLICATIONS

this patent application claims priority to, and incorporates fully by reference, U.S. Provisional Patent Application No. 62/181,260 filed on Jun. 18, 2015.

This patent application claims priority to, and incorporates fully by reference, and is a continuation in part of U.S. patent application Ser. No. 14/859,529 filed on Sep. 21, 2015.

### BACKGROUND OF THE INVENTION

Field of the Invention

This invention relates generally to road, or portable, accessories, and in particular, to foldable and collapsible umbrellas.

Background Art

Different umbrella designs are known in the prior art. U.S. Pat. No. 6,334,454 by Williams discloses an umbrella that is collapsible and has a cap. The cap can act as a handle for the umbrella for removing the cap from the umbrella and then reattaching the handle via screw threads.

US Patent Application Publication No. 2005/0098199 A1 by Ko discloses an umbrella which is housed in a hinged case. The case can be opened, the umbrella removed and deployed and the case than reattached to the base of the umbrella shaft as an umbrella handle.

Chinese Patent 2,390,458 Y discloses an umbrella with a removable handle attached by threaded screw that is interchangeable.

U.S. Pat. No. 911,636 by Whitlock discloses a folding umbrella. The umbrella has a hollow shaft with a hinged section. Inside the hollow shaft there is a second shaft that moves within the hollow shaft. The second shaft has two hinges. When the hinges of the hollow shaft and second shaft are manipulated to have the hinges overlap then the umbrella can be folded.

DE 2,460,620 by Garray discloses a folding umbrella with a rotating hinge. The hinge has a clip that keeps the hinge locked in a non-folded position. The clip is overcome and undone by sufficient torque.

### SUMMARY OF THE INVENTION

The objective of the invention is to improve properties of an umbrella taking into account convenience and comfort through ergonometric requirements, and to create a. new fashion trend. The invention consists of an umbrella, with a hinged handle.

The folding umbrella uses a hinge in either the shaft or handle. The hinge has a closed and open position. The hinge has a retainer section and a button section. The retainer section and the button section are hingedly connected by a hinge pin. The retainer section has a hinge locking retainer that protrudes from the retainer section into a hinge locking retainer detent in the button section. The hinge locking retainer and the hinge locking retainer detent each have a bore that is coaxial when the hinge is in the closed position. The button section has a button bore located between the hinge pin and the hinge locking retainer detent. The button bore has a button that protrudes to an outside of the button section. The button is backed by a spring. The button is biased by the spring to be out in a non-pressed position. When the button is put in a pressed position it pushes against the spring and against a u-shaped locking pin. Within the button section the button bore and the locking retainer detent bore are connected by a locking pin chamber. When the button is in the non-pressed position the u-shaped locking pin passes through the locking retainer detent bore, if the hinge is in the closed position the u-shaped locking pin also passed through the bore of the hinge locking retainer thereby locking the hinge in the closed position. When the button is in the pressed the button and spring push u-shaped locking pin out of the bore of the hinge locking retainer thereby allowing the hinge to be moved from the closed to the open position or from the open to the closed position.

### BRIEF DESCRIPTION OF THE DRAWINGS

The present invention will now be discussed in further detail below with reference to the accompanying figures in which:

FIG. 1 shows folding umbrella handle in closed position with button non-pressed position.

FIG. 2 shows folding umbrella handle in closed position with button in pressed position.

FIG. 3 shows folding umbrella handle in open position with button in pressed position.

FIG. 4 shows folding umbrella handle in open position with button in non-pressed position.

FIG. 5 shows handle connected to the umbrella.

FIG. 6 shows the handle disconnected from the umbrella.

FIG. 7 shows a top view of the handle locking mechanism.

FIG. 8 show the handle connected to the umbrella.

FIG. 9 shows the handle disconnected from the umbrella.

FIG. 10 show the handle connected to the umbrella.

FIG. 11 shows the handle disconnected from the umbrella.

FIG. 12 shows alternative view of the handle connected to the umbrella.

FIG. 13 shows alternative view of the handle disconnected to the umbrella.

FIG. 14 shows alternative view of the handle connected to the umbrella.

### DETAILED DESCRIPTION OF THE PREFERRED EMBODIMENTS

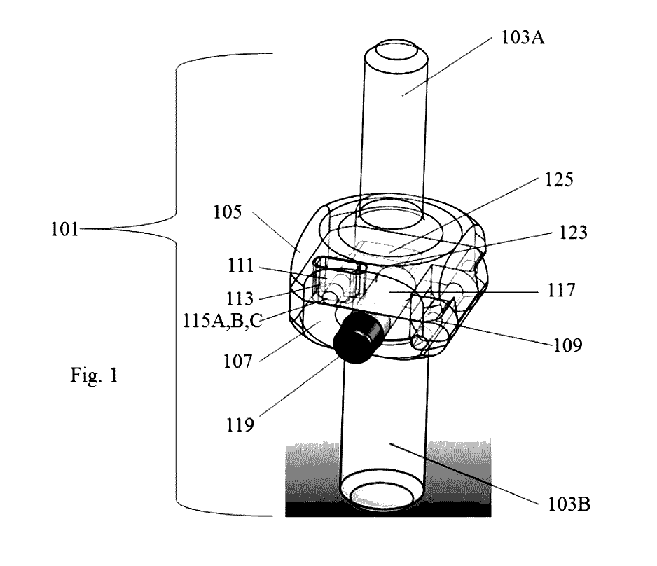

The following detailed description concerns FIGS. 1-4. The figures are drawn so as to be transparent to best show all the parts contained within the folding umbrella hinge.

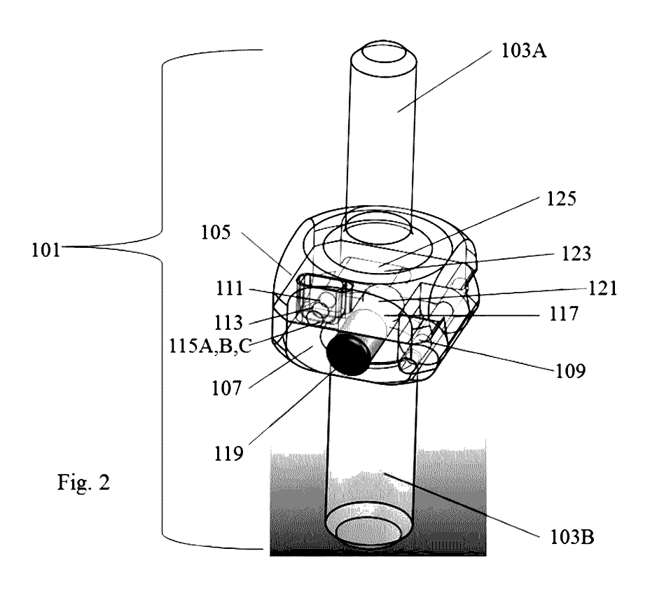

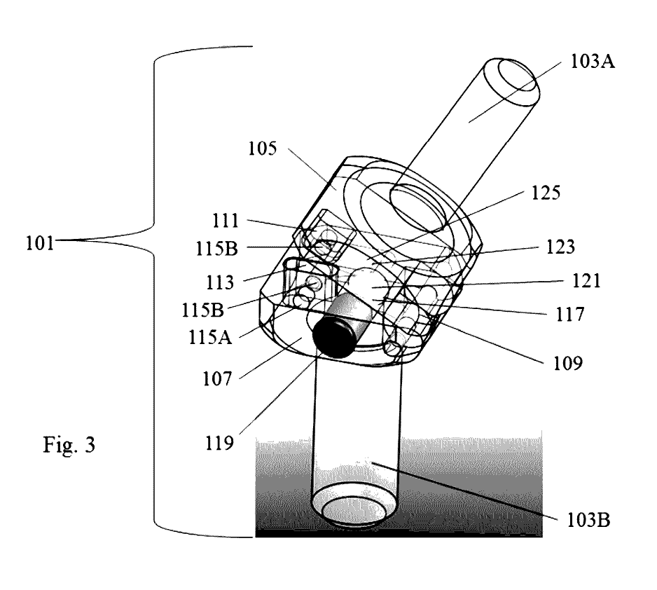

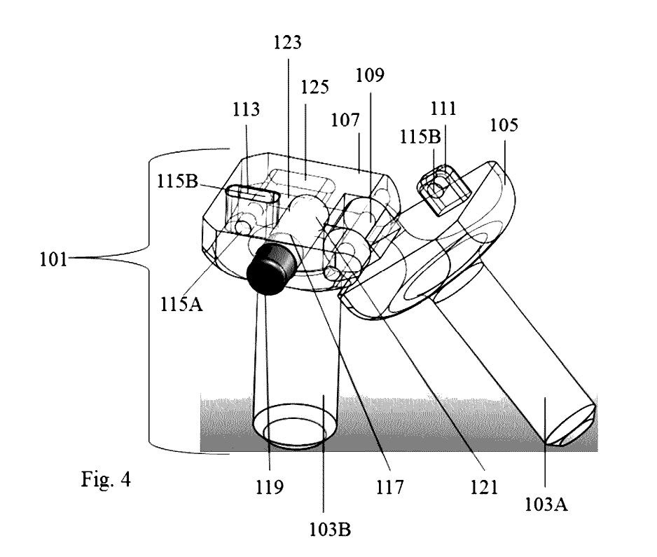

The folding umbrella uses a hinge 101 in either the shaft or handle 103A and 103B. The hinge 101 has a closed (FIGS. 1 and 2) and open position (FIGS. 3 and 4). The hinge 101 has a retainer section 105 and a button section 107. The retainer section 105 and the button section 107 are hingedly connected by a hinge pin 109. The retainer section 105 has a hinge locking retainer 111 that protrudes from the retainer section 105 into a hinge locking retainer detent 113 in the button section 107. The hinge locking retainer 111 and the hinge locking retainer detent 113 each have a bore 115 (A, B, and C) that is coaxial when the hinge is in the closed position (FIGS. 1 and 2). The button section 107 has a button bore 117 located between the hinge pin 109 and the hinge locking retainer detent 113. The button bore 117 has a button 119 that protrudes to an outside of the button section 107. The button is backed by a spring 121. The button 119 is biased by the spring 121 to be out in a non-pressed position (FIGS. 1 and 4). When the button 119 is put in a pressed position (FIGS. 2 and 3) it pushes against the spring 121 and against a u-shaped locking pin 123. Within the button section 107 the button bore 117 and the locking retainer detent bore 115 (A and C) are connected by a locking pin chamber 125. When the button 119 is in the non-pressed position (FIGS. 1 and 4) the u-shaped locking pin 123 passes through the locking retainer detent bore 115A and 115C, if the hinge 101 is in the closed position (FIG. 1) the u-shaped locking pin 123 also passed through the bore 115B of the hinge locking retainer 111 thereby locking the hinge in the closed position (FIG. 1.). When the button 119 is in the pressed position (FIGS. 2 and 3) the button 119 and spring 121 push the u-shaped locking pin 123 out of the bore 115B of the hinge locking retainer 111 thereby allowing the hinge 101 to be moved from the closed position (FIG. 2) to the open position (FIG. 3) or from the open position (FIG. 3) to the closed position (FIG. 2).

The following is a description of a method of use of the folding umbrella hinge. Having a hinge 101 that has an open position (FIGS. 3 and 4) and a closed position (FIGS. 1 and 2). The binge 101 being operated by a button 119. When pushing (FIGS. 2 and 3) the button 119 the button 119 pushes against a spring 121 and a u-shaped locking pin 123 removing the u-shaped locking pin 123 from a bore 115 (A-C) in a hinge locking retainer 111 allowing the hinge 101 to move between the open position (FIGS. 3 and 4) and the closed position (FIGS. 1 and 2). When the button 119 is not being pushed (FIGS. 1 and 4) the u-shaped locking pin 123 is in a locking position (FIG. 1) passing through bores 115B in a retainer section 105 which when the hinge is in the closed position. (FIG. 1) also passes through a hinge locking retainer 111 and 115B locking the hinge in the closed position (FIG. 1).

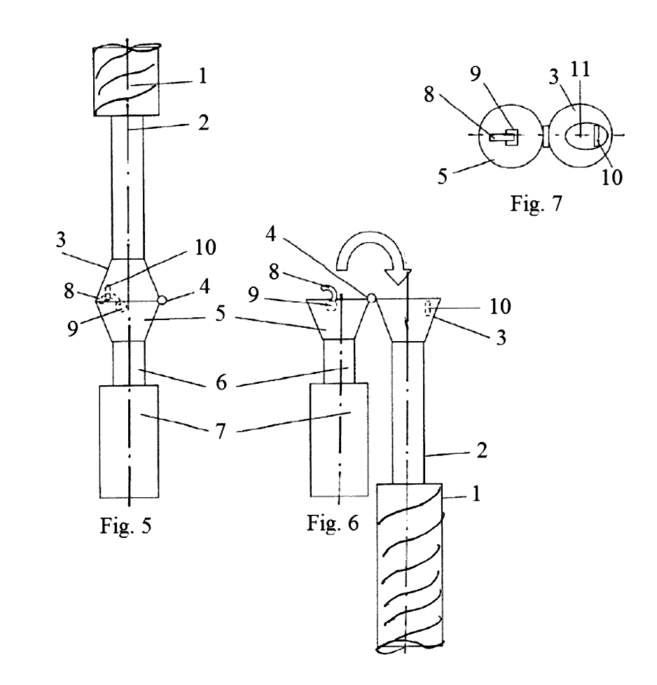

FIG. 5 shows the invention which includes an umbrella cupola 1 at the end of umbrella rod 2 connected to a handle locking mechanism made up of a first part of the lock handle 3 with a hinge 4 connecting to the second pan of the lock handle 5, the first part of the lock handle 3 contains a lock slot 10 and an element retainer 11. The second part of the lock handle 5 has a slot/recess for the lock 9 an axle lock 8. FIG. 5 shows the invention with the parts of the lock handle 3 and 5 and hinge 4 in its locked positions. A rod handle 6 is connected to the second part of the lock handle 5 and a handle 7 is connected to the end of the rod handle 6.

This configuration of the hinge is unique, because locking and unlocking is performed with one button (one finger). Other types of locking use one button for locking and another for unlocking.

The umbrella and umbrella, handle 7 wherein the handle has a diameter of 1 to 3 cm. The umbrella and umbrella handle 7 wherein the handle has a length of 10 to 20 cm. This invention is regarding handheld umbrellas and specifically not in the field of beach or table umbrellas.

FIG. 6 shows the invention with the parts of the lock handle 3 and 5 and hinge 4 in its open and unlocked positions.

FIG. 7 shows a top view of the locking mechanism made up of a part of the lock handle 3 with a hinge 4 connecting to the second part of the lock handle 5, the first part of the lock handle 3 contains a lock slot 10 and an element retainer 10.

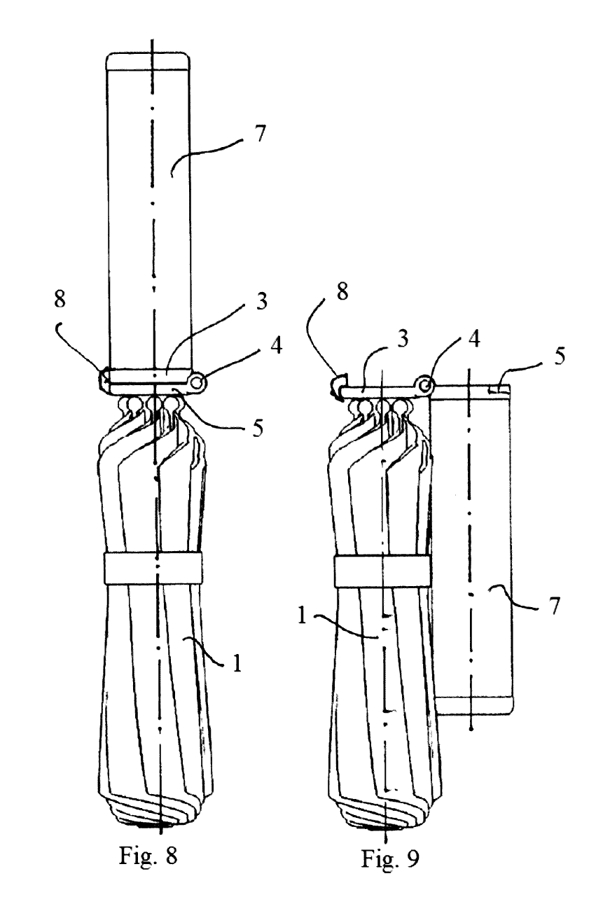

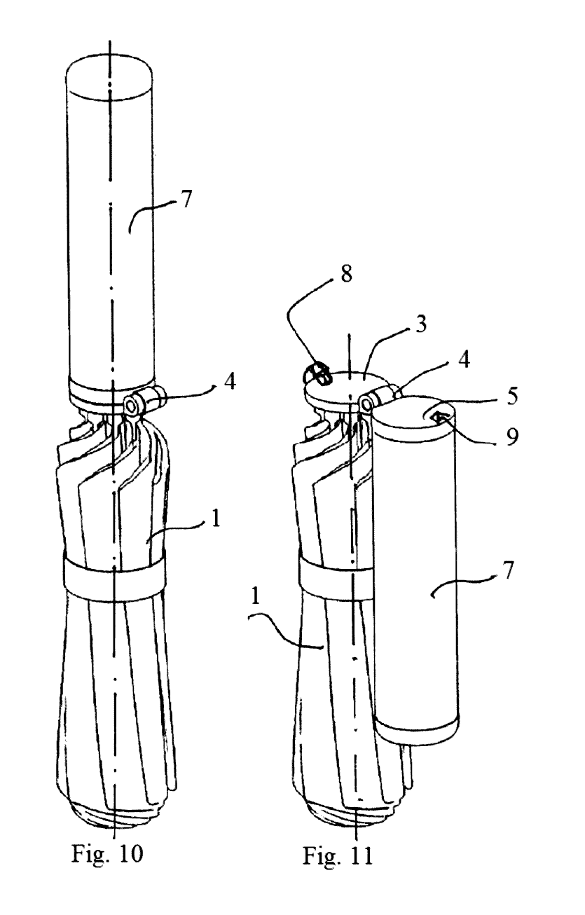

FIGS. 8 and 10 show the invention with the parts of the lock handle 3 and 5 and hinge 4 in its locked positions with the axle lock 8 as an external part of the locking mechanism with first part. of the lock handle 3 with a hinge 4 connecting to the second part of the lock handle 5.

FIG. 9 shows the invention with the parts of the lock handle 3 and 5 and hinge 4 in its open unlocked positions with the axle lock 8 as an external part of the locking mechanism with first part of the lock handle 3 with a hinge 4 connecting to the second part of the lock handle 5.

FIG. 9 shows the invention with the parts of the lock handle 3 and 5 and hinge 4 in its open/unlocked positions with the axle lock 8 as an external part of the locking mechanism with first part of the lock handle 3 with a hinge 4 connecting to the second part of the lock handle 5 and with a slot/recess for the lock 9.

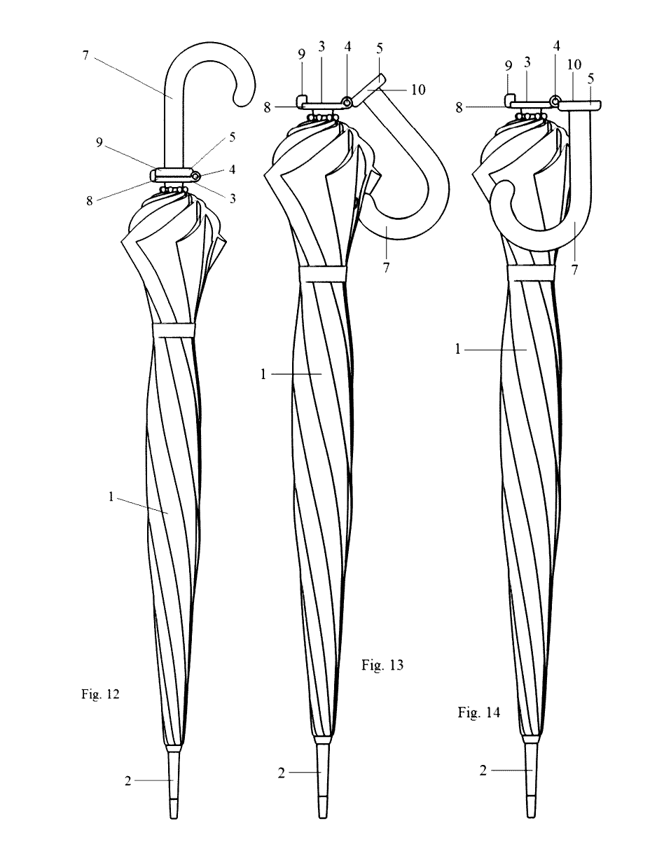

FIG. 12 shows alternative view of the handle with the locking mechanism in the locked position. FIG. 13 shows alternative view of the handle with the locking mechanism in an open/unlocked position. FIG. 14 shows alternative view of the handle with the locking mechanism in an open/unlocked position.

The invention also includes a method for connecting an umbrella handle to an umbrella rod by attaching the handle to the rod of the umbrella with a joint coupling element mounted on one edge of the rod; the joint allows rotation of the handle by 180 degrees; and fixing the handle in a position co-axial with the rod by a fixing mechanism which firmly connects the handle and the rod with each other. The umbrella wherein the fixing mechanism is a movable clamp. The umbrella wherein the fixing mechanism is located on an opposite edge of the umbrella compared to a position of the joint.

It will be appreciated by a person skilled in the art that numerous variations and/or modifications may be made to the present invention as shown in the specific embodiments without departing, from the spirit or scope of the invention as broadly described. The present embodiments are, therefore. to be considered in all respects to be illustrative and not restrictive.

What is claimed is:

1. A method for connecting an umbrella handle to an umbrella rod, comprising:
a. having a hinge that has an open position and a closed position;
b. the hinge being operated by a button;
c. when pushing the button the button pushes against a spring and a u-shaped locking pin removing the u-shaped locking pin from a bore in a hinge locking retainer allowing the hinge to move between the open position and the closed position;
d. when the button is not being pushed the u-shaped locking pin is in a locking position passing through bores in a retainer section which when the hinge is in the closed position also passes through a hinge locking retainer locking the hinge in the closed position.

2. A folding umbrella, comprising:
a. an umbrella cupola at one end of a shaft and a handle at an other end of the shaft;
b. a hinge divides the shaft into two parts;
c. the hinge has a closed position and an open position;
d. the hinge has a retainer section and a button section;
e. the retainer section has one part of the shaft connected to it and the button section has another part of the shaft connected to it;
f. the retainer section and the button section are hingedly connected by a hinge pin;
g. the retainer section has a hinge locking retainer that protrudes from the retainer section into a hinge locking retainer detent in the button section;
h. the hinge locking retainer and the hinge locking retainer detent each have a bore that is coaxial when the hinge is in the closed position;
i. the button section has a button bore located between the hinge pin and the hinge locking retainer detent;
j. the button bore has a button that protrudes to an outside of the button section;
k. the button is backed by a spring;
l. the button is biased by the spring to be out in a non-pressed position,
m. when the button is put in a. pressed position it pushes against the spring and against a u-shaped locking pin;
n. within the button section the button bore and the locking retainer detent bore are connected by a locking pin chamber;
o. when the button is in the non-pressed position the u-shaped locking pin passes through the locking retainer detent bore, if the hinge is in the closed position the u-shaped locking pin also passed through the bore of the hinge locking retainer thereby locking the hinge in the closed position;
p. when the button is in the pressed the button and spring push u-shaped locking pin out of the bore of the hinge locking retainer thereby allowing the hinge to be moved from the closed position to the open position or from the open position to the closed position.

3. The umbrella and umbrella handle of claim 2, wherein the handle has a diameter of 1 to 3 cm.

4. The umbrella and umbrella handle of claim 2, wherein the handle has a length of 10 to 20 cm.

5. A folding umbrella, comprising:
a. an umbrella cupola at one end of a shaft and a handle at an other end of the shaft;
b. a hinge divides the handle into two parts;
c. the hinge has a closed position and an open position;
d. the hinge has a retainer section and a button section;
e. the retainer section has one part of the handle connected to it and the button section has another part of the handle connected to it;
f. the retainer section and the button section are hingedly connected by a hinge pin;
g. the retainer section has a hinge locking retainer that protrudes from the retainer section into a hinge locking retainer detent in the button section;
h. the hinge locking retainer and the hinge locking retainer detent each have a bore that is coaxial when the hinge is in the closed position;
i. the button section has a button bore located between the hinge pin and the hinge locking retainer detent;
j. the button bore has a button that protrudes to an outside of the button section;
k. the button is backed by a spring;
l. the button is biased by the spring to be out in a non-pressed position;
m. when the button is put in a pressed position it pushes against the spring and against u-shaped locking pin;
n. within the button section the button bore and the locking retainer detent bore are connected by a locking pin chamber;
o. when the button is in the non-pressed position the u-shaped locking pin passes through the locking retainer detent bore, if the hinge is in the closed position the u-shaped locking pin also passed through the bore of the hinge locking retainer thereby locking the hinge in the closed position;
p. when the button is in the pressed the button and spring push u-shaped locking pin out of the bore of the hinge locking retainer thereby allowing the hinge to be moved from the closed position to the open position or from the open position to the closed position

6. The umbrella and umbrella handle of claim 5, wherein the handle has a diameter of 1 to 3 cm.

7. The umbrella and umbrella handle of claim 5, wherein the handle has a length of 10 to 20 cm.
